(19) United States
(12) Patent Application Publication
(10) Pub. No.: US 2011/0249114 A1
(43) Pub. Date: Oct. 13, 2011

(54) Image display and recording apparatus and a recording medium on which a category control program is recorded

(75) Inventor: Akira Ezawa, Kawasaki-shi (JP)

(73) Assignee: NIKON CORPORATION, Tokyo (JP)

(21) Appl. No.: 13/067,655

(22) Filed: Jun. 17, 2011

Related U.S. Application Data
(63) Continuation of application No. 12/216,429, filed on Jul. 3, 2008, now abandoned.
Application No. 12/216,429 is a continuation of application No. 10/721,454, filed on Nov. 26, 2003, now abandoned.
Application No. 10/721,454 is a continuation of application No. 10/073,936, filed on Feb. 14, 2002, now abandoned.
Application No. 10/073,936 is a continuation of application No. 09/086,471, filed on May 28, 1998, now abandoned.

(30) Foreign Application Priority Data
May 28, 1997 (JP) 09138721

(51) Int. Cl. H04N 5/253

(52) U.S. Cl. 348/96; 348/E05.049

(57) ABSTRACT

An image display and recording apparatus displays at least one image which belongs to a category as a heading image which shows that category. The heading images are selected from a plurality of images recorded in memory. The display of the heading images allows the content of each category to be grasped at one glance when selecting the category. The heading images may be used when displaying the categories of the images in various types of displays. Such displays include an index screen, a cartridge list screen, a category list screen, a category index screen, a story list screen, and a story index screen.

This is a Continuation of application Ser. No. 12/216,429 filed Jul. 3, 2008, which in turn is a Continuation of application Ser. No. 10/721,454 filed Nov. 26, 2003, which in turn is a Continuation of application Ser. No. 10/073,936 filed Feb. 14, 2002, which is a Continuation of application Ser. No. 09/086,471 filed May 28, 1998. The entire disclosure of each of the prior applications is hereby incorporated by reference herein in its entirety.

### INCORPORATION BY REFERENCE

The disclosure of the following priority application is herein incorporated by reference: Japanese Patent Application No. 09-138721, filed May 28, 1997.

### BACKGROUND OF THE INVENTION

1. Field of Invention

The present invention relates to an image display and recording apparatus which records and displays a plurality of images, and to a recording medium on which is recorded a category control program which, in particular, has an improved categorization function for categorizing a plurality of images.

2. Description of Related Art

Devices are known in which images may be photographed by a camera and converted into electronic data. The electronic data may then be recorded on different kinds of media. These electronic images may then be viewed with the aid of a computing device.

These electronic images may be categorized by choosing a category from a list of category names, such as “landscapes”, “travel,” and the like, in which the electronic image is to be stored.

However, with the prior art image display devices, since the category of each image has to be decided after reading a plurality of category names that are displayed in a category list, it takes time to read and decide on a category for the image. Also, since new category names have to be input by the user, the operation of the known systems can be disadvantageously bothersome.

### SUMMARY OF THE INVENTION

In view of these problems with the known systems, the present invention provides an image display and recording apparatus and a recording medium on which is recorded a category control program in which the image category operation ability is improved.

According to one aspect of the present invention, an image display and recording apparatus categorizes and displays a plurality of images that are recorded on a recording medium. At least one image which belongs to the category is displayed as a heading of the category.

Another aspect of the present invention is that the image for the heading, which indicates the category, is designated to be an image which was first assigned to that category. The heading image is changeable to an arbitrary image which belongs to that category.

The images of a plurality of film cartridges can be recorded on the recording medium. The images are arranged in categories which include, for example, a cartridge category, an image content category, and a story category in which arbitrary images are arranged in an arbitrary order.

A category control program is stored on a recording medium. The category control program categorizes a plurality of images that are recorded in memory. The category control program displays at least one image which belongs to the category as a heading. The category control program designates the heading image to be the image that was first assigned to that category. However, the heading image is changeable to an arbitrary image which belongs to that category.

### BRIEF DESCRIPTION OF THE DRAWINGS

The embodiments of the present invention will be described with reference to the following figures, wherein like numerals designate like elements, and wherein:

FIG. 1 shows the structure of one embodiment of the image display and recording apparatus according to the present invention;

FIG. 2 shows the structure of the imaging component of the image display and recording apparatus of FIG. 1;

FIG. 3 is an example of an electric circuit diagram of the image display and recording apparatus of FIG. 1;

FIG. 4 shows an example of a remote controller for use with the image display and recording apparatus of FIG. 1;

FIG. 5 shows a film cartridge of the IX240 type, which may be used with the image display and recording apparatus of FIG. 1;

FIG. 6 is a diagram of the back surface of the cartridge shown in FIG. 5;

FIG. 7 is a flow chart which shows the operation of the image display and recording apparatus when only a cartridge is loaded;

FIG. 8 is a flow chart which shows the operation of the image display and recording apparatus when a cartridge and ZIP disk or only a ZIP disk is loaded, continuing from FIG. 7;

FIG. 9 is a flow chart which shows the operation of the image display and recording apparatus, continuing from FIG. 8;

FIG. 10 is a flow chart which shows the operation of the image display and recording apparatus, continuing from FIG. 9.

FIG. 11 shows an example of an index screen according to the present invention;

FIG. 12 shows an example of a rotated frame image of FIG. 11;

FIG. 13 is another example of a rotated frame image;

FIG. 14 shows an example of a frame screen of type H;

FIG. 15 shows an example of a frame screen of type C;

FIG. 16 shows an example of a frame screen of type P;

FIG. 17 shows an example of a display of the frame screen in a first mode;

FIG. 18 shows an example of a display of the frame screen in a second mode;

FIG. 19 shows an example of a display of the frame screen in a third mode;

FIG. 20 shows an example of a cartridge list screen according to the present invention;

FIG. 21 shows an example of a category list screen according to the present invention;

FIG. 22 shows an example of a category index screen according to the present invention;

FIG. 23 shows an example of a category index screen according to the present invention;

FIG. 24 shows an example of a category index screen according to the present invention;

FIG. 25 shows an example of a story list screen according to the present invention; and

FIG. 26 shows an example of a story index screen according to the present invention.

### DETAILED DESCRIPTION OF PREFERRED EMBODIMENTS

In one embodiment of the present invention, recorded frame images are categorized according to various concepts after imaging the images of each frame that are recorded on IX240 film, converting the images into electronic data, and recording the electronic data in a cartridge unit on a ZIP disk.

The type of film that may be used with the present invention is not limited to IX240 film. For example, 35 mm film may also be used. Likewise, the recording medium of the image is not limited to a ZIP disk. For example, a magnetic disk, magnetooptic disk, hard disk, CD-ROM, DVD-ROM, magnetic tape or electromagnetic disk other than a ZIP disk can be used.

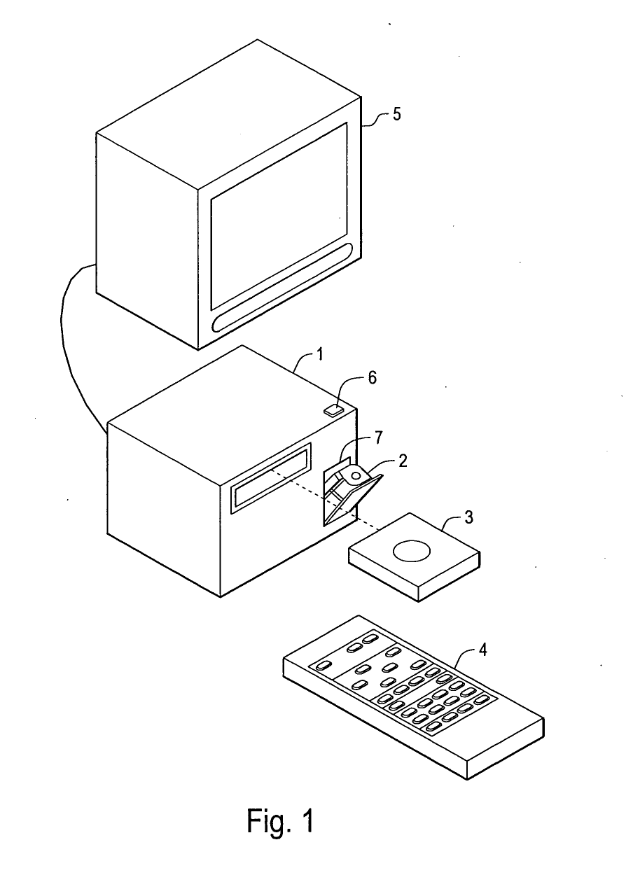

FIG. 1 shows the structure of one embodiment of the present invention. The image display apparatus 1 is structured so that an IX240 film cartridge 2 which has already been developed can be loaded in the cartridge chamber 7. The ZIP disk 3 also is loaded into its chamber. The image of each frame which is recorded in the film cartridge 2 is imaged and converted into electronic data. This can be done, for example, using a CCD. The electronic data is then recorded on the ZIP disk 3. The image display apparatus 1 is controlled by the remote controller 4. The image display apparatus 1 is controlled so that images that are read are output and displayed on a monitor 5. The monitor 5 may be, for example, a Cathode Ray Tube (CRT) device, conventional television, Liquid Crystal Display (LCD), touch screen display and the like.

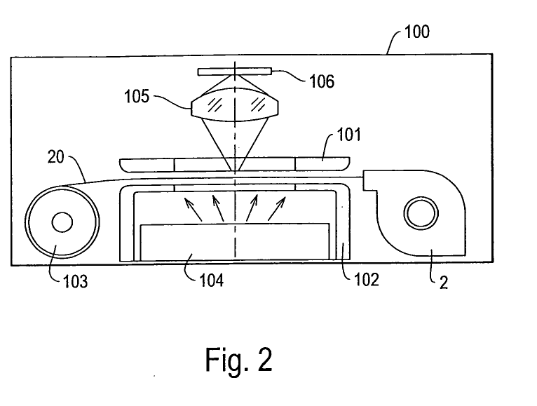

FIG. 2 shows the structure of the imaging component 100 of the image display apparatus 1. The image display device 1 houses the imaging component 100. The film 20, from the film cartridge 2, is wound by the winding spool 103 via the guide members 101 and 102. The image which is recorded in each frame of the film 20 is illuminated by the illuminating device 104, and an image of the frame is formed on the imaging element 106 (e.g., CCD) by the lens 105. The image is then converted to an image signal by the imaging element 106.

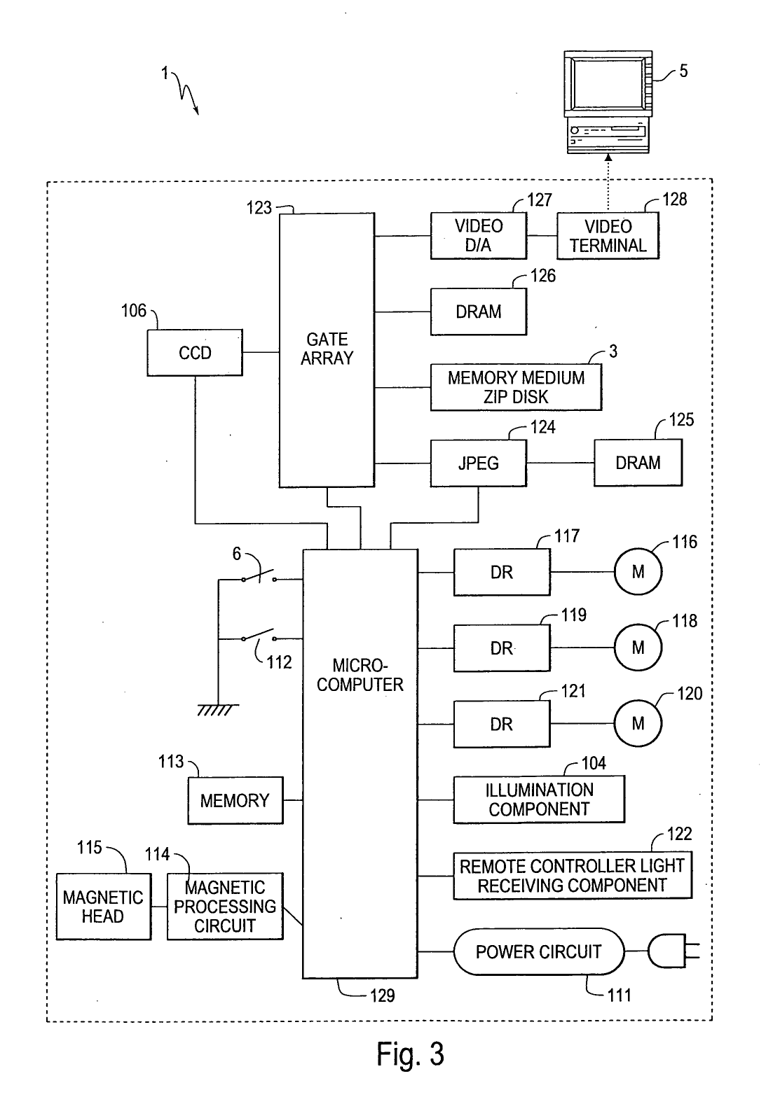

FIG. 3 shows the electrical circuitry of the image display apparatus 1. The electrical circuitry of the image display device 1 is structured around the microcomputer 129. When the power switch 6 is turned on, power is supplied from a power supply circuit 111 of the image display device 1. The load detection switch 112 is turned on when the film cartridge 2 is loaded in the cartridge chamber 7. A memory 113 stores various kinds of information necessary for operation of the image display apparatus. A magnetic processing circuit 114 replays magnetic information which is recorded on the film 20 by driving a magnetic head 115. A zoom motor 116 is driven by a driver 117, and performs enlargement and reduction of the images by zooming a lens 105 of the imaging component 100 up and down. A loading motor 118 is driven by a driver 119 and loads the film cartridge 2 into the cartridge chamber 7. A film feeding motor 120 is driven by a driver 121, and feeds the film 20 from cartridge 2. The remote controller light receiving component 122 receives signals sent from the remote controller 4.

The gate array 123 is a circuit that processes an image to create a reduced image. The JPEG-IC 124 is a circuit to perform compression and decompression of the image according to the JPEG (Joint Photographic Experts Group) standards. DRAM 125 is a RAM for use during the decompression and compression of images and DRAM 126 is a RAM for image display. The DRAM 126 is also used for creating and updating many kinds of index screens. The microcomputer 129 controls the entire operation of the image display device 1 by controlling the above-mentioned components.

When an image is displayed on the monitor 5, the image data is first read-out to the DRAM 125 from the ZIP disk 3. The image data is then decompressed by the JPEG-IC 124 and stored in the DRAM 126. The image data then is transferred from the DRAM 126 to the video D/A converter 127 where it is converted to an analog image signal and output to the video terminal 128. The video terminal 128 then outputs the image signals to the monitor 5.

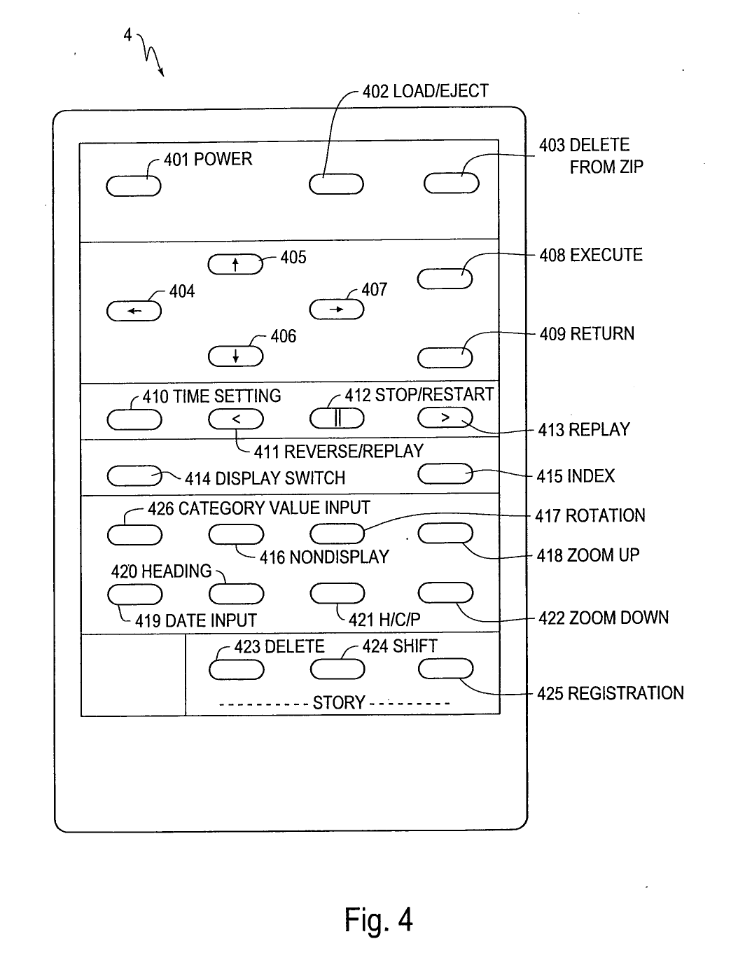

FIG. 4 shows the operating components of the remote controller 4. Each of the operating components of the remote controller 4 is explained in order in turn in the operation description given hereafter.

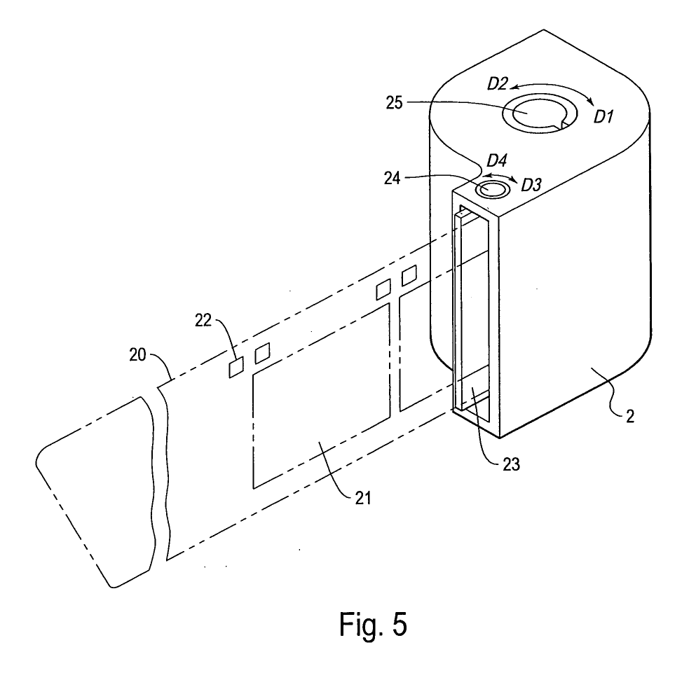

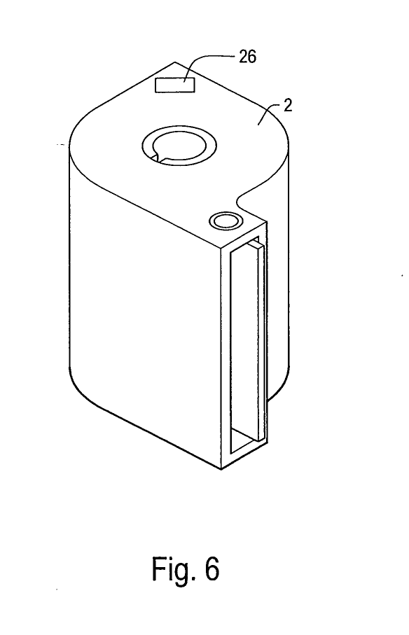

FIGS. 5 and 6 show the film cartridge 2. The film cartridge 2 shown is of the IX240 type, however, other film types may be used without departing from the spirit and scope of the present invention. The IX240 film 20 not only has perforations 22 formed at predetermined positions of the photographic frame 21, but also has a magnetic track (not shown). A light shielding door 23 is provided in the film cartridge 2. The opening and closing of the light shielding door 23 is performed by rotating the shaft 24. The forwarding and rewinding of the film 20 can be performed by opening the light shielding door 23 and rotating the spool shaft 25.

Additionally, the film cartridge 2 is equipped with a non-developed display tab 26 provided on the back surface of the film cartridge 2. The tab 26 is removed at the time of developing at the lab. The non-developed display tab 26 can be used to distinguish whether the film has been developed.

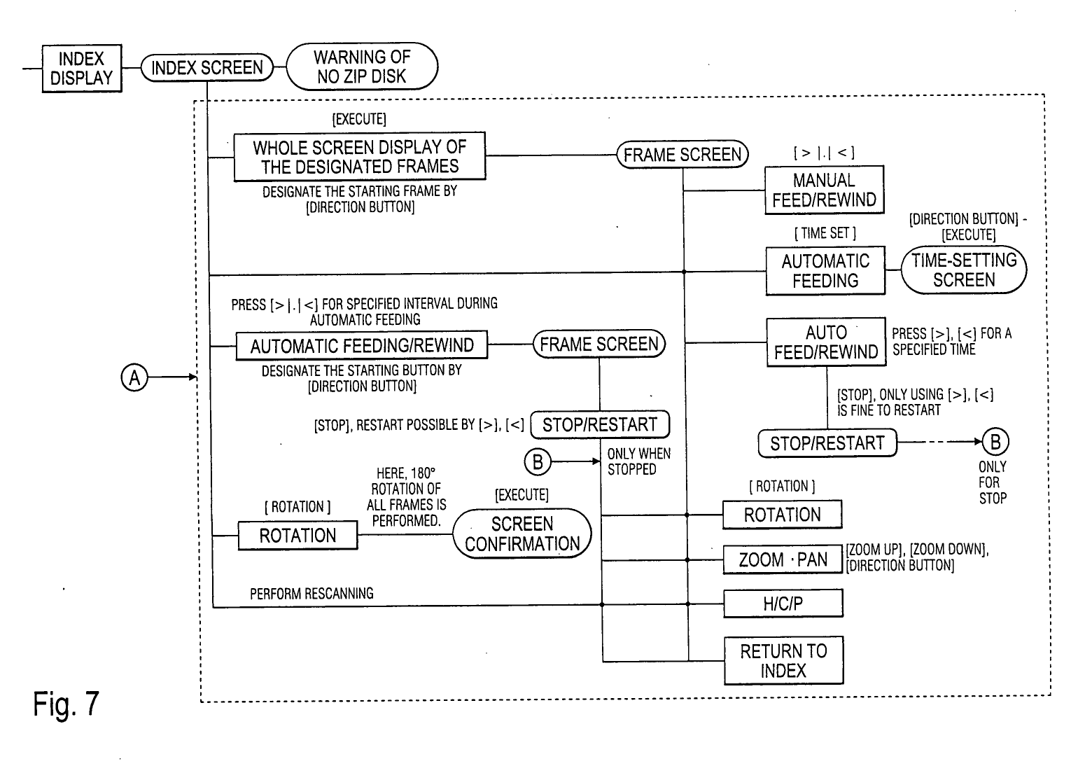

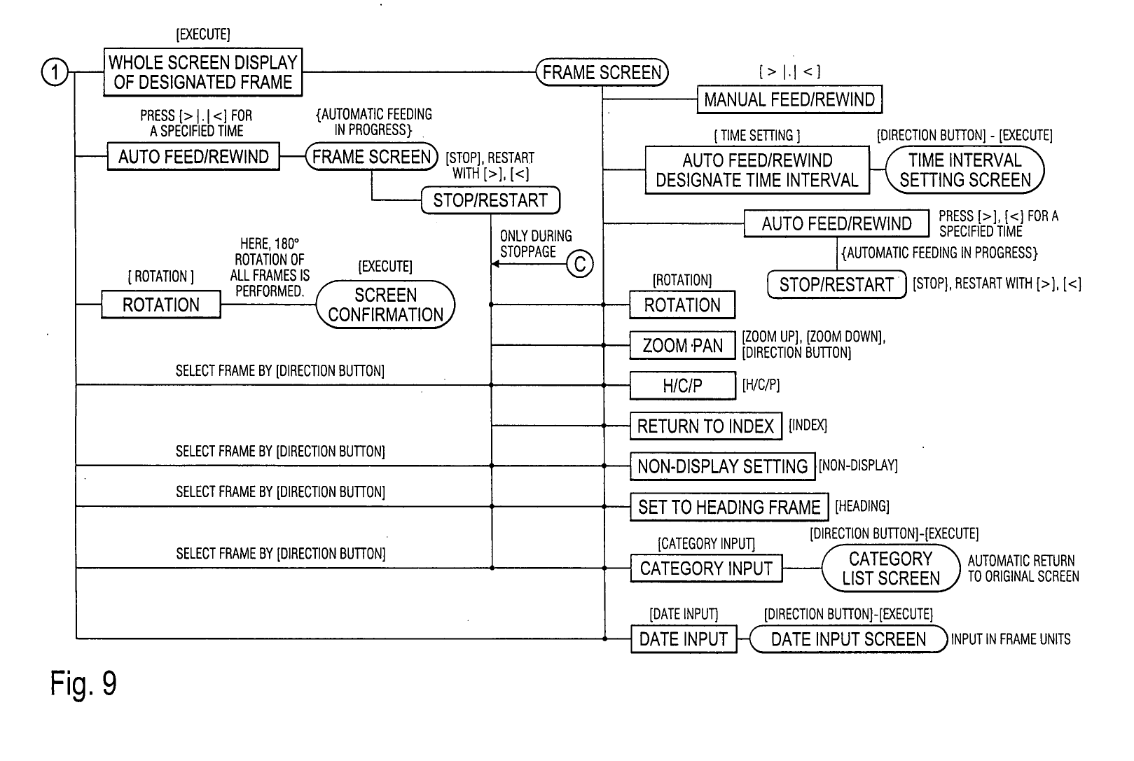

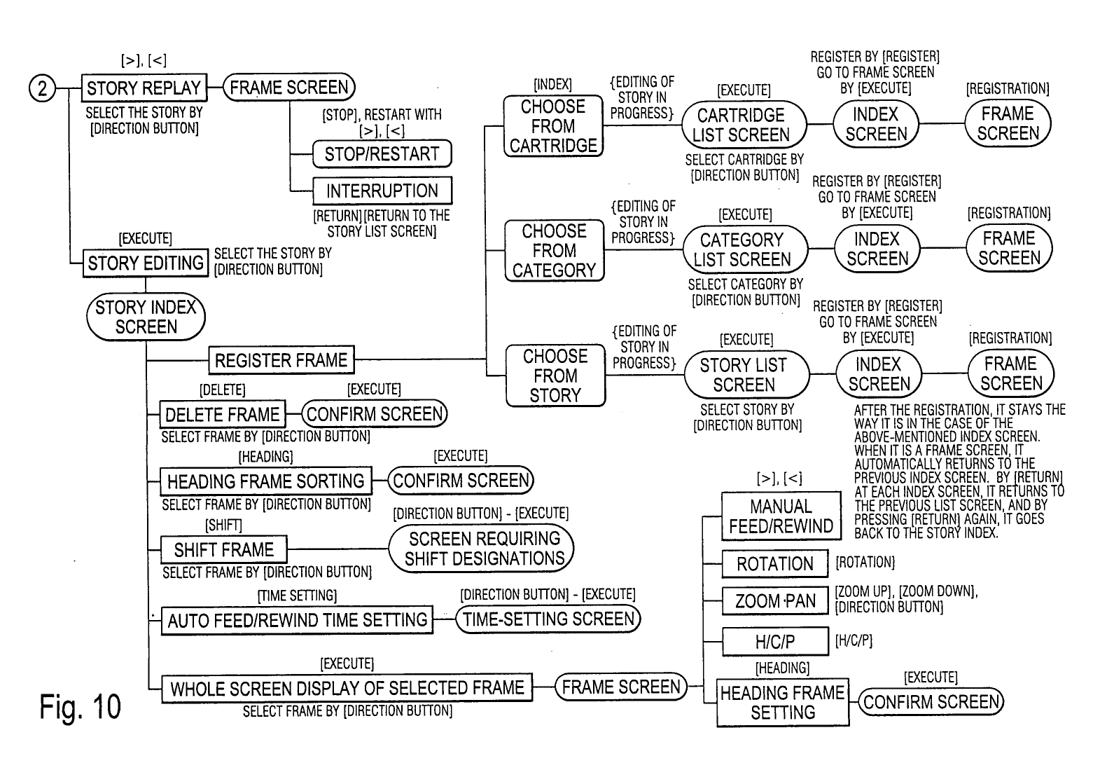

Next, the operation of the present embodiment is explained according to the flow charts that are shown in FIGS. 7-10. In FIGS. 7-10, the square boxes denote functions to be performed, the square boxes with the round edges denote supplemental functions, the long round boxes denote the display of the screen, and the double long round boxes denote temporary text imposing screens which display messages and the like. Furthermore, the [ . . . ] shows the remote controller button 4 which is operated when executing that function. Additionally, circle marks are added at the crossing points of the vertical and the horizontal lines that connect each screen and each function. At these crossing points, lines which come from the left pass the crossing points and proceed to the right, and lines from the top can proceed through the crossing points to the bottom and to the right.

The operation of reading in an image from the film cartridge, creating an index image and a frame image, and recording the image will now be explained with reference to FIG. 7.

When the developed film cartridge 2 is loaded in the cartridge chamber 7 and the load/eject button 402 is operated, the film cartridge 2 is automatically wound and the film 20 is wound by the winding spool 103. At this winding time, the magnetic information which is recorded on the magnetic track of each frame is read by the magnetic processing circuit 114 and the magnetic head 115. The magnetic information is then recorded in the ZIP disk 3. When the replay of the magnetic information of all frames is completed, the final frame is set to the position which is opposite to the CLD 106 and the read-out of the image is started.

An image which is read-out from the CCD 106 is first reduced (e.g., thinned-out) by the gate array 123 and then recorded in the DRAM 126 to be used as an index image. Further, the image which is read-out by the CCD 106 is stored in the DRAM 125, compressed by the JPE6-IC 124, and then recorded in the ZIP disk 3. This image read-out operation is performed on all the frames. Index images of all the frames are created on the DRAM 126 by reducing the images of the film cartridge 2. The index images are stored in the DRAM 125, compressed by the JPEG-IC 124, and then recorded in the ZIP disk 3.

The image display apparatus 1 is capable of displaying, for example, an index screen, a cartridge list screen, a category list screen, a category index screen, a story list screen, and a story index screen. These screens are described in detail hereafter.

### Index Screen

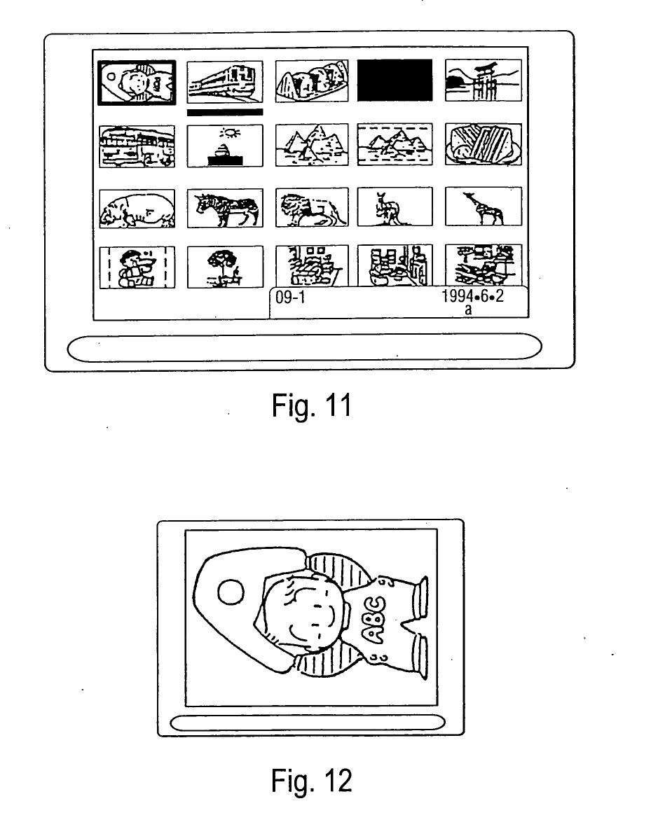

FIG. 11 shows an example of the index screen of the present invention. The index screen is a screen on which the frame images which are recorded in one film cartridge are arranged in order starting from the first frame. The index screen allows all the frame images in the film cartridge to be viewed in a reduced form, thus enabling multiple frames to be viewed at once.

When a function is executed with respect to arbitrary frame images, it is necessary to first select the frame images. The bold frame, which surrounds the frame image, shows the selected frame image. The index screen shown in FIG. 11 shows an example of when the first frame, (the upper left frame) is selected. The bold frame, which shows the selected frame image, can be shifted to an arbitrary frame image by the direction buttons 404˜407 of the remote controller 4.

The frame image in FIG. 11 with an underline displayed beneath the frame is the frame image which is set as the heading of the cartridge. This frame image is displayed on the cartridge list screen described hereafter. The index screen example shown in FIG. 11 shows the underline displayed under the second frame. Thus, in this example, the second frame is set as the heading frame image for this cartridge.

An information window for displaying information is provided at the lower right-hand corner of the index screen. The information of the selected frame, i.e., the cartridge number (09), the selected frame number (1), date (Jun. 2, 1994) and the category value (a) are displayed in this information window. The cartridge number is given in order of input into the ZIP disk 3.

The operation of the index screen and the frame screen will now be explained with reference to FIG. 7. When the ZIP disk 3 is not loaded and only the film cartridge 2 is loaded in the image display device 1 and the index button 415 is operated, the display operation of the index screen of the loaded film cartridge 2 is executed. The index screen shown in FIG. 11 is then displayed on the monitor 5. However, at this time, since the ZIP disk 3 is not loaded, a warning message is displayed on the monitor 5 that no ZIP disk is loaded.

When the index screen is displayed, a frame image is designated by shifting the bold frame by the direction buttons 404˜407 and operating the execution button 408 on the remote controller 4. The full screen display of the designated frame image is then displayed on monitor 5. In this state, the replay button 143 or the reverse replay button 411 can be operated to perform “manual feed and rewind.” In this way, the full screen display of the next frame image or the previous frame image can be performed.

When the index screen is displayed, the starting frame image is designated by the direction buttons 404˜407. When the replay button 413 or the reverse replay button 411 is pressed for a certain time, the automatic frame feeding or rewind is performed and, after a full screen display is performed for a predetermined time, it is automatically switched, in order from the designated frame image, to the next frame image or the previous frame image. After displaying the final frame, the display returns to the index screen automatically, and is completed. At this time, the last frame which is displayed in the end becomes selected. When the user wishes to suspend the automatic feeding/rewinding during the execution of the rewinding/feeding, the stop/restart button 412 is pressed. At this time, the last displayed frame becomes selected. Moreover, when the user wishes to restart the automatic feeding/rewind, the automatic feeding/rewind will be started from the selected frame image if the replay button 413, the reverse replay button 411 or the stop/restart button 412 is pressed.

When the time setting button 410 is pressed, the time setting screen (not shown) is displayed, and an arbitrary automatic feeding/rewind time can be set by the direction buttons 404˜407 and the execute button 408. With IX240 film, the photographed date is recorded on the film as magnetic information. When the magnetic information of the film cartridge 2 and the image are recorded to the ZIP disk 3, the photographed date, which is recorded in each frame, is recorded as the default date of the frame image. However, it is possible to revise this photographed date. Moreover, it is possible to add a date to a frame which was photographed by a camera which does not have the function to magnetically record the date. When the date is input at the index screen or the frame screen, the date is added to the selected frame. Moreover, when the date is input at the later-mentioned cartridge list screen, a message is displayed asking whether the date is to be added only to the frame of the selected cartridge on which no date is recorded or added to all frames.

### Editing of an Image's Attributes

When the image of a certain frame is displayed on the monitor 5, the display of the image can be edited in the following manner.

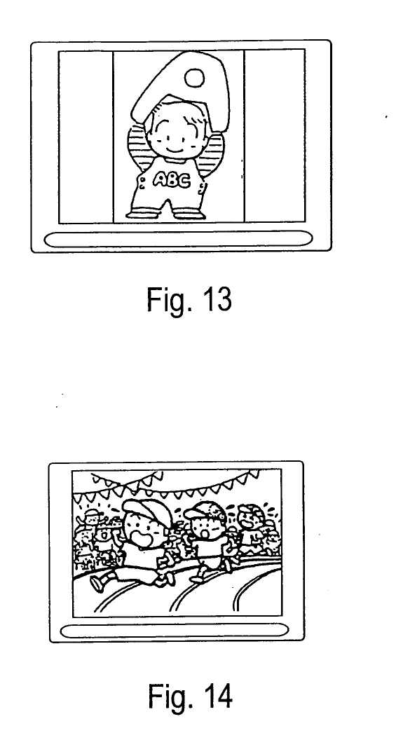

(1) Rotation of the frame unit: The orientation of the image on the frame screen can be changed in units of 90 degrees. Every time the rotation button 417 is pressed while the frame image screen is displayed, the image is rotated 90 degrees clockwise. Zooming is performed automatically to show the vertical or the horizontal full screen display with the same aspect ratio. If the later-mentioned zoom/pan functions have already been performed, these operations are canceled. However, the result of the rotation is not reflected on the index screen. FIG. 13 shows the result of the 90 degree rotation of the image of FIG. 12.

(2) Rotation of the cartridge unit: When the frame image is of a cartridge photographed by a reverse direction loading camera, the image is displayed upside down. Therefore, with respect to this kind of cartridge, all the frame images are rotated 180 degrees and displayed. When an arbitrary cartridge is selected and the rotation button 417 is pressed at the index screen or the later-mentioned cartridge index screen, the message of “Is it OK to rotate all the frames of the cartridge 180 degrees?” is displayed. If the execute button 408 is pressed, all the frame images of all cartridges are rotated by 180 degrees.

(3) Zoom/pan: The zoom/pan function not only performs zoom up and zoom down with respect to the frame screen, but also shifts the frame image up, down, to the right and to the left. When the zoom up button 418 is pressed, the frame screen is zoomed up. When the zoom down button 422 is pressed, the frame screen is zoomed down. For panning, the screen is shifted incrementally for a specified amount when the direction buttons are pressed. The zoom/pan function cannot be performed at the index screen.

(4) Print type (H/C/P) selection: With IX240 film, the vertical and the horizontal ratio of the print can be selected from high vision type (H), classic type (C) and panorama type (P). The print type which was selected at the time of photographing is magnetically recorded on the film as magnetic information. This magnetic information is read by the magnetic processing circuit 114 and the magnetic head 115. The default print type is displayed by masking the top and bottom or the left and right, in accordance with this magnetic recording information.

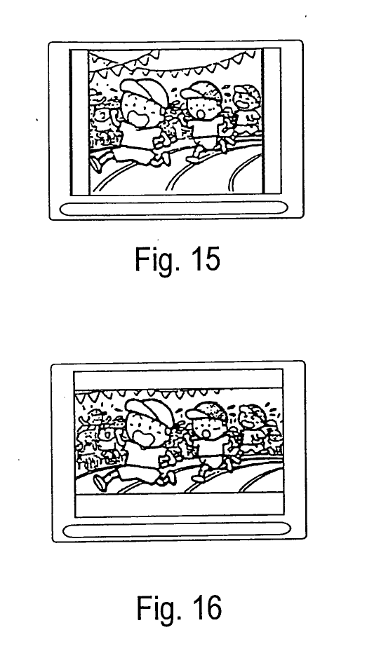

When the H/C/P button 421 is pressed at the frame screen or the index screen, the aspect ratio is switched in order from H to C to P and back to H. Here, if the zoom/pan function has been performed, the zoom/pan condition is canceled. Moreover, at the index screen, P type or C type is displayed through vertical or horizontal lines. At the index screen which is shown in FIG. 11, the ninth frame shows the example of type P, and the sixteenth frame shows the example of type C. Moreover, FIG. 14 shows an example of an H type screen display of a frame. FIG. 15 shows an example of a C type screen display of a frame. FIG. 16 shows an example of a P type screen display of a frame.

(5) Non-display: This is an attribute which is set so that the image is not shown. The attribute is set by the non-display button 416. Only shading is displayed in a frame for which the non-display attribute is set. The image having the non-display attribute set cannot be viewed until the setting is released by pressing the non-display button 416 again. In the example shown in FIG. 11, the non-display setting is on for the fourth frame, which cannot be viewed.

(6) Heading frame: In the later-mentioned cartridge list screen, the heading frame image of each cartridge is displayed one by one. The default value of the heading image frame is the first frame. However, any.other frame image can be designated to be the heading frame image by selecting the other frame at the index screen shown in FIG. 11 and pressing the heading button 420. An underline is displayed, such as shown in the second frame of FIG. 11, at the bottom part of the frame image which is designated to be the heading frame image. Similarly, the heading frame image of each category (the default frame is the first frame given the category value) in the later-mentioned category list screen and the heading frame image of each story (the default frame is the first frame of that story) in the story list screen can be arbitrarily designated.

When the attribute(s) of an image is/are edited in the manner set forth above, the newest attribute setting for the image is recorded on the ZIP disk 3 with the image. In the above-mentioned attributes, the rotation, zoom/pan, H/C/P and the non-display attributes can be designated in the index screen and story screen.

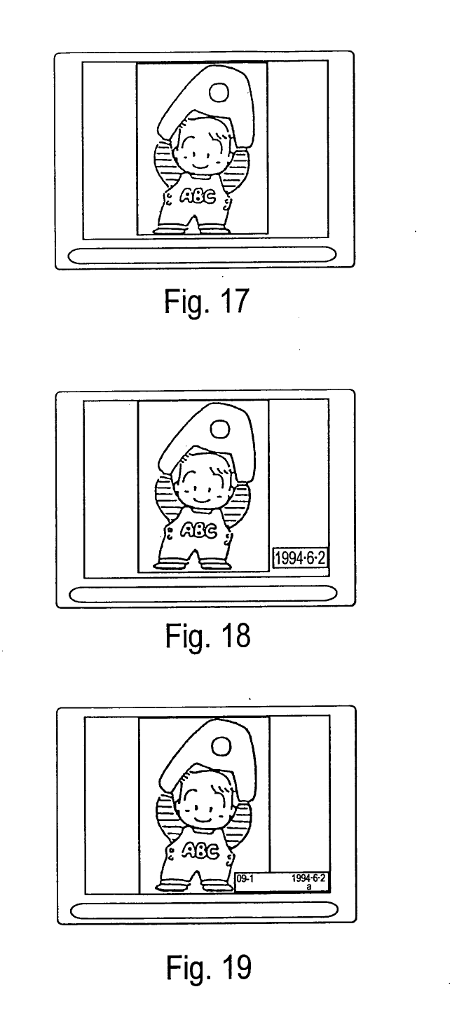

FIGS. 17-19 show frame screen examples. A frame screen is the full display of one frame on the monitor 5. In the display example of FIGS. 17-19, the image of the first frame of FIG. 11 is rotated by 90 degrees and displayed. The top and bottom of the image is fully displayed on the monitor screen, and the left and right of the screen are masked. The information display is not displayed in FIG. 17. Every time the display switch button 414 is pressed, the information display switches in order between the non-display mode, which is shown in FIG. 17, the display mode for only the date (Jun. 2, 1994), which is shown in FIG. 18, and the display mode for the cartridge number (09), the frame number (1), the date (Jun. 2, 1994) and the category value (a), which is shown in FIG. 19.

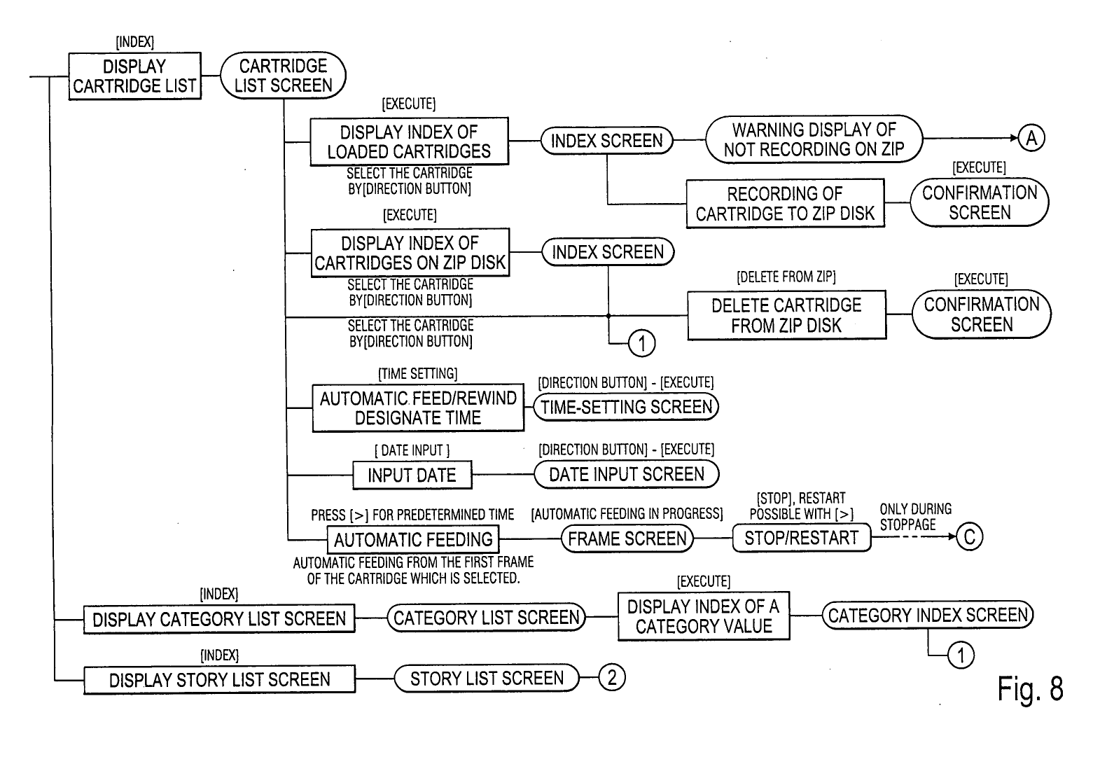

According to FIGS. 8-10, the operations with respect to the cartridge list screen, the category list screen, the category index screen, the story list screen, the story index screen and the like are explained.

When the film cartridge 2 and the ZIP disk 3, or only the ZIP disk 3, are loaded in the image display device 1 and the index button 415 is pressed, the display switches in order between the cartridge list display, the category list display and the story list display every time the index button is pressed.

### Cartridge List Screen

In the cartridge list screen, the heading frame of each cartridge is read out in order from the ZIP disk 3 to the DRAM 125, and is decompressed at the JPEG-IC 124. A reduced image is created at the gate array 123, and the reduced image is added to the list images on the DRAM 126. When the heading frame image of all the cartridges have been assembled, they are transferred to the DRAM 125, compressed by the JPEG-IC 124, and recorded in the ZIP disk 3. When a film cartridge is newly recorded in the ZIP disk 3, the next time the cartridge image list is requested, the heading frame image of the new cartridge is added and the cartridge list images are updated.

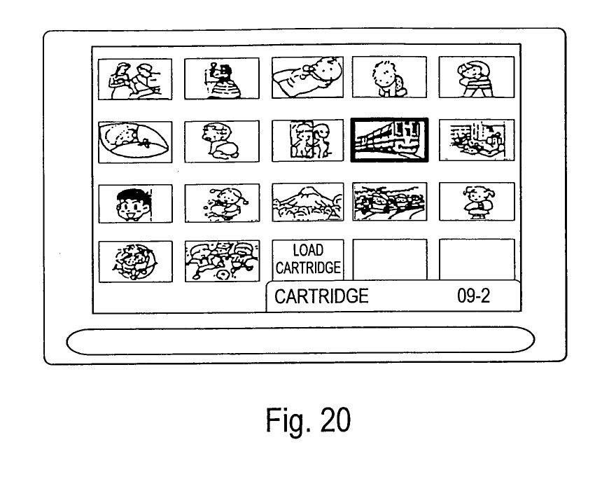

FIG. 20 shows the cartridge list screen. The cartridge list screen is a screen in which the heading frame image of each cartridge is arranged. The default value of the heading frame image is the first frame of each cartridge. However, it is possible to change the heading frame to another frame image in the cartridge in order to set the other frame as the heading frame image that represents the cartridge. As with the index screen, the selected heading frame image is surrounded by a bold frame. In the right bottom information window, the selected cartridge number (09) and the heading frame number (2) of the cartridge are displayed.

While the cartridge list screen is displayed when the “load cartridge” (the eighteenth frame of FIG. 20) is designated by the direction buttons 404˜407 and the execution button 408 is pressed, the index screen of the loaded cartridge is displayed and the recording of the cartridge to the ZIP disk 3 can be performed while watching a confirmation screen. Moreover, when a record of a cartridge on the ZIP disk is designated and the execution button 408 is pressed, the index screen of the designated cartridge is displayed. Here, the record of the designated cartridge can be deleted from the ZIP disk 3 by actuating the button 403 while watching the confirmation screen.

In the cartridge list screen, the above-mentioned automatic feeding time designation, date input, and automatic feeding can be performed. However, automatic rewinding cannot be performed. The automatic feeding is performed in order starting from the first frame of the selected cartridge(s). After the last frame of the last cartridge has been displayed, the automatic feeding returns to the cartridge list screen and is completed. At this time, the last cartridge selected is kept as the selected cartridge.

### Categorization

The image display device 1 basically records the frame images to the ZIP disk 3 in cartridge units and is provided with a function to categorize comprehensively depending on the content of the frame image. An arbitrary category value can be designated with respect to each frame image. The category value information of each frame is recorded in the ZIP disk 3. In this embodiment, there are a total of ten category values designated as a, b, c, . . . , j. A maximum number of five category values can be designated to each frame by overlapping the frame into more than one category. The category value for the frame is displayed in the information display described above. Moreover, the index display of the frame images may be performed for each category.

### Category List Screen

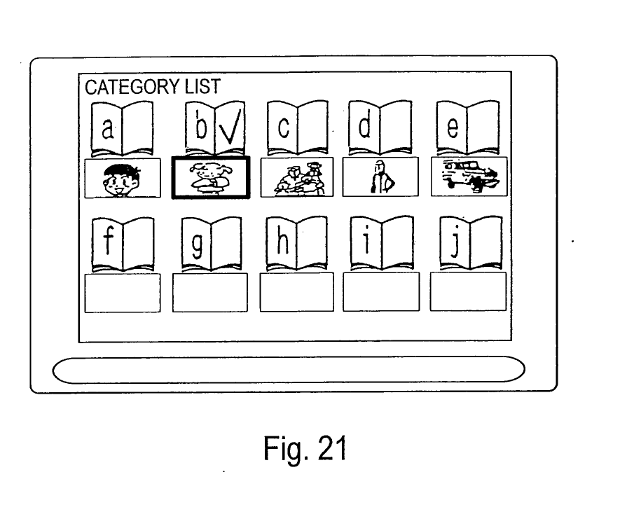

FIG. 21 shows an example of a category list screen according to the present invention. The category list screen is a screen for deciding the category value when adding the category value to a certain frame image or for displaying the category index of arbitrary category values. The category values a˜j are displayed with symbols indicating files. The heading frame image of each category is displayed below the symbols. The category value is selected by shifting the bold frame which surrounds the heading frame image. For example, when a category value is added to a certain frame image, the category value is selected by operating the direction buttons 404˜407 and pressing the execution button 408. When the category value is added, a check mark is displayed at the right side of the character of the category value, as shown in the category value b of FIG. 21. The check mark indicates that the category value is added to the frame image.

For the heading frame images, which are displayed on the category list screen, the default heading frame image becomes the frame image to which the category value was first added. However, it is also possible to change the heading frame image to another frame image that adequately expresses that category.

FIG. 21 shows the category values as alphabetical expressions, however, other category values may be used that more adequately describe the category. The various possible categorizations depend on the user's preferences. Moreover, which category is allotted to each category value can be viewed at one glance by displaying the heading frame image for each category. Thus, it is unnecessary to include a function for inputting a character line such as “travel” to express the category. Therefore, the categorizing function is simplified.

For the category list screen, the heading frame image of each category is read out successively from the ZIP disk 3 to the DRAM 125 and decompressed at the JPEG-IC 124. A reduced image is created at the gate array 123 and then added to the list of images on the DRAM 126. When adding the heading frame images of all the categories is completed, the heading frame images are transferred to the DRAM 125, compressed by the JPEG-IC 124, and recorded in the ZIP disk 3. When a category is newly created, the next time the category list image is requested, the heading frame image of the new category is added and the category list image is updated.

### Category Value Input and Delete

When the category value input button 426 is pressed while a frame image is displayed, the category list screen is displayed. When the execution button 408 is pressed after designating the category value by the direction buttons 404˜407, the category value is set for the frame image. To set a plurality of category values for the same frame image, the above-mentioned operation is repeated for each category value. Moreover, after the category values are input, the display automatically returns to the previous screen from the category list screen.

When the category value input button 426 is pressed while a frame image is displayed, the category list screen is displayed and the category values which have already been designated are displayed in a different color from those that have not been designated. When the execution button 408 is pressed after designating a category value to be canceled by the direction buttons 404˜407, the designated category value is canceled. The canceled frame image is automatically deleted at the later-mentioned category index and the next frame image is moved over to fill the empty space. The display returns to the previous frame screen from the category list screen after the category values have been canceled.

### Category Index Screen

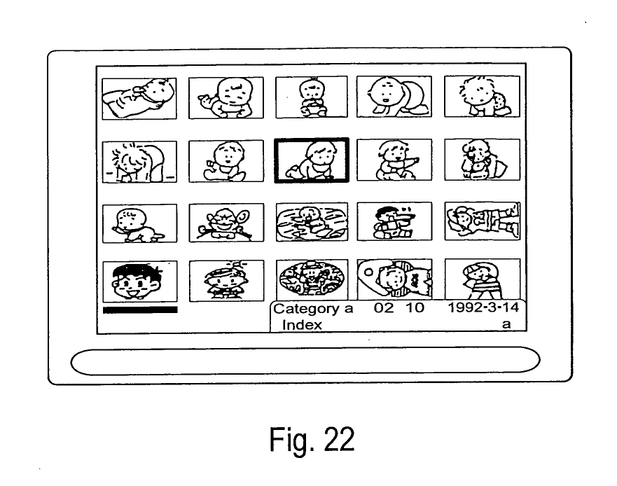

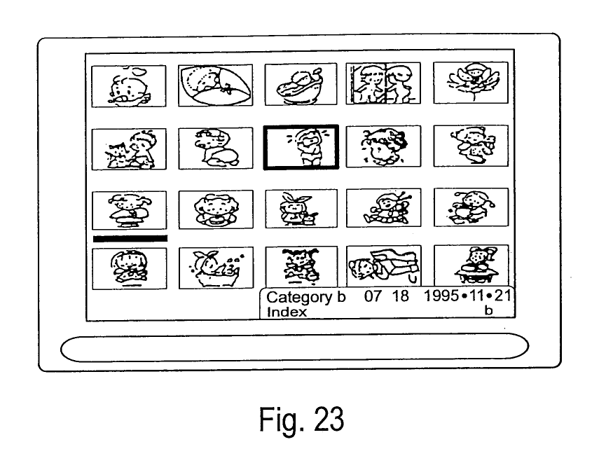

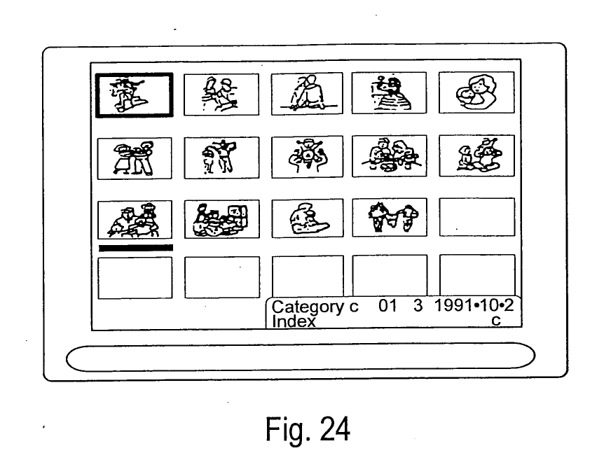

The category index list screen is displayed by the index button 415. When a category value in the category index list screen is designated by the direction buttons 404˜407 and the execution button 408 is pressed, the category index screen of the designated category is displayed. For example, when the “oldest first son” of the category value “a” is designated at the category list screen, which is shown in FIG. 21, the category index screen of the category “a”, shown in FIG. 22, is displayed. Similarly, when the “oldest daughter” of the category value “b” is designated, the category index screen of the category value “b”, shown in FIG. 23, is displayed. When the “family” of the category value “c” is designated, the category index screen of the category value “c”, shown in FIG. 24, is displayed. The bold frame shows the selected frame and the underline shows the heading frame of the category in each category index screen.

For the category index list screen, the frame images which belong to the category are read out in order from the ZIP disk 3 to the DRAM 125 and decompressed at the JPEG-IC 124. A reduced image is created by the gate array 123, then added to the list of images on the DRAM 126. When all of the frame images that belong to the category have been added, they are transferred to the DRAM 125, compressed by the JPEG-IC 124, and recorded to the ZIP disk 3.

At the category index list screen, it is possible to display the frame images of the designated frames, to automatically feed and rewind, and to rotate the images. The automatic feeding and rewinding at the category index list screen starts the automatic feeding or the rewinding from the selected frame image. After displaying the end frame image, the automatic feeding/rewinding is completed by returning to the category index list screen. At this time, the last displayed frame image is kept as selected. Moreover, in order to quit in the middle of feeding/rewinding, the return button 409 is pressed and the display returns to the category index list screen. At this time, the last displayed frame image is kept as selected. Moreover, in the frame screen of the designated frame, editing of the above-mentioned attributes of the image is possible.

### Story List Screen

The image display device 1 is provided with a story list screen that arranges arbitrary frame images, that are recorded in the ZIP disk 3, in an arbitrary order making them into a movie-like story and replaying them one by one at a specified time interval. In the present embodiment, the story exists in a ZIP disk unit. As for the story, not only the frame images, but also other stories can be treated and registered with the same concept as the frame images.

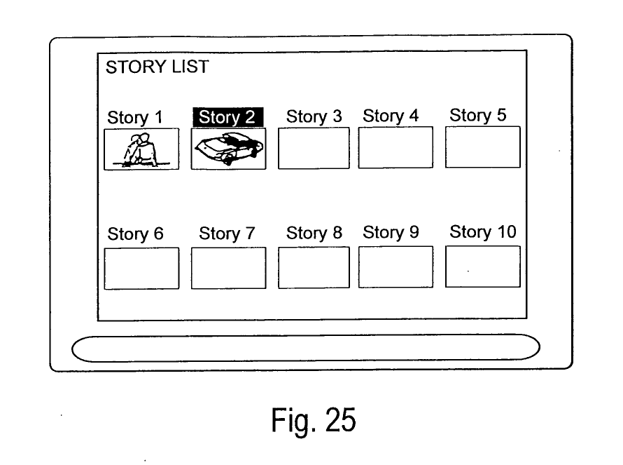

FIG. 25 shows an example of the story list screen according to the present invention. At the story list screen, the number of each story and the heading frame images are displayed. The default frame of this heading frame image is the first frame of the story. However, it is possible to change the heading frame to the best frame image that expresses the story. An arbitrary story can be selected by controlling the direction buttons 404˜407 at the story list screen. The currently selected story number is displayed in a color inversion manner as shown by “Story 2” in FIG. 25.

For the story list screen, the heading frame image of each story is read out in order to the DRAM 125 from the ZIP disk 3, and decompressed by the JPEG-IC 124. A reduced image is created by the gate array 123 and then added to the list of images on the DRAM 126. When the heading frame images of all the stories have been added, they are transferred to the DRAM 125, compressed by the JPEG-IC 124, and then recorded to the ZIP disk 3. If the story is newly created, when the story list screen is next requested, the heading frame of the new story is added and the story list images are updated.

### Story Index Screen

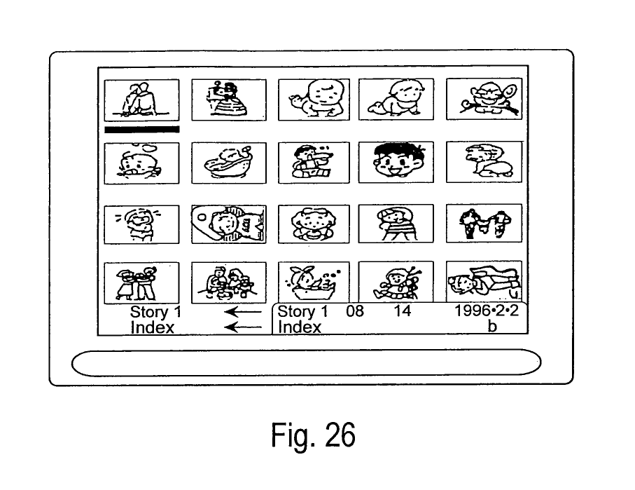

FIG. 26 shows an example of the story index screen of the story 1 of FIG. 25. When an arbitrary story is selected at the story list screen and the execution button 408 is pressed, the frame images that belong to the story are index displayed in order. At the story index screen, the selected frame image is displayed with a bold frame and the heading frame image of the story is displayed with an underline. Moreover, in the information window of the lower right corner, the cartridge number of the selected frame (08), the frame number (14), the date (Feb. 3, 1994), and the category value (b) are displayed.

The Registration and Deletion of a Frame Image to/from a Story

The display is shifted to the story list screen by the index button 415. The story which is to be edited is selected and the story index screen is displayed. The image at the position the user wishes to additionally register is designated by the direction buttons 404˜407 and the additional registered frame can be designated by the following method.

(1) When in the cartridge list screen, the cartridge is designated and the index screen is displayed. Next, the frame images desired to be added to the story are selected and the register button 425 is pressed.

(2) When in the category list screen, the category value is selected and the category index screen is displayed. Next, the frame images desired to be added to the story are selected and the register button 425 is pressed.

(3) When in the story list screen, the story is selected and the category index screen is displayed. Next, the frame images desired to be added to the story are selected and the register button 425 is pressed.

Moreover, when another story is selected at the story list screen and the registration button 425 is pressed, the newly selected story is registered in the story that was being manipulated before the newly selected story was selected.

When a frame image is selected in the story index screen and the delete button 423 is pressed, the frame screen which belongs to the story is deleted. At this time, if there are any frame images after the deleted frame image, those frame images are shifted to the left into the empty space. Further, when a story is selected at the story list screen and the delete button 423 is pressed, the story is deleted. At this time, if there are any stories after the deleted stories, those stories are shifted to the left into the empty space.

When a frame image to be shifted is selected in the story index screen and the shift button 424 is pressed, a superimposed screen is displayed which requests the designation of the shifting destination. The shift destination is designated by operating the direction buttons 404-407. When the direction buttons 404˜407 are operated, the superimposed screen disappears. When the shift destination is designated and the execution button 408 is pressed, the frame image is shifted to the designated destination.

When changing the heading frame image which is displayed at the story list screen to a frame image other than the first frame, if the desired frame image to be set as the heading is designated by the direction buttons 404˜407 and the heading button 420 is pressed, the underline is displayed on the bottom of the designated heading frame image and it is set to be the heading frame image.

When changing the story number, the story to change is selected at the story list screen and the shift button 424 is pressed. A super imposed screen which requests the designation of the shifting destination is displayed. The shift destination is designated by operating the direction buttons 404˜407. When the direction buttons 404˜407 are operated, the superimposed screen disappears. When the draft destination is designated and the execution button 408 is pressed, the story number is changed. Here, when a story is already registered at the shift destination, the warning display of “invalid” is displayed.

To replay a story, the story to be replayed is selected at the story list screen and the replay button 413 is pressed. The frames which belong to the selected story are then displayed one by one at a specified time interval. The information display during the replay of the story, may have any of the following optional display styles: (1) images only; (2) display of “story n is being replayed No. n/m frame” on an information window at the lower right corner; and (3) display of “story n is being replayed, No. n/m frame” and “photographed date” on the information window of the lower right corner can be selected by the display switch button 414. In order to stop the replay in the middle of execution, the return button 409 is pressed and the display automatically returns to the story list screen.

The story index screen, which is shown in FIG. 26, shows the index screen of “family”, which is the story 1 shown in FIG. 25. This family's story, begins with the marriage of the parents, the birth of the first son, and continues through the growth of the children. Each image belongs to a plurality of cartridges. By arranging the frame images along with the one story as shown, a film-like story can be developed by using the still images.

In order to create this story, rather than assembling the images by viewing the index of each cartridge, the story can be created simply by extracting the frame image of the oldest son from the category “a,” the frame image of the oldest daughter from the category “b” and the frame image of the family from the category “c”. Moreover, when creating other stories with the theme of the family, it is possible to select the images from the index screen of the story 1 which was already created.

Furthermore, with respect to the frame images that are registered in the story, since the effective attributes can be set in the story display, it is possible to show the images a different way from the way they were displayed at the cartridge index or the category index. For example, it is possible to set a condition such that all the frames are zoomed up only for the story display.

Moreover, in the above-mentioned embodiment, in the category list screen and the story list screen, the example was shown of displaying one heading frame with respect to each story. However, the number of the heading frames is not limited to one, and it is appropriate to set two or more heading frames with respect to each category value and each story.

As explained above, in the present invention, since at least one image which belongs to a category is displayed as a heading which shows that category, the content of each category can be grasped at one glance when selecting the category and the category can be quickly selected. Moreover, there is no need to input the category name from an input device. Therefore the category operation ability can be improved.

Additionally, since the image for the heading which shows the category is made to be the image which was first assigned to the category, and also is made to be changeable to an arbitrary image, the heading image of the category can be automatically decided and controlled. Since the heading is changeable to another image if necessary, the category workability can be improved by changing the image to an image which best expresses the category well.

In the described embodiment, a film cartridge was supplied to the image display device 1, and the image frames on the cartridge were scanned. The invention also is applicable to “cartridges” that hold digital images. For example, digital still cameras typically store a limited number (e.g., 20-60) digital images on a memory device. The image display device 1 of the invention can be adapted to receive the limited number of images, either by receiving a removable memory card (holding the 20-60 digital images) from a digital camera, or by coupling (either by hardware or wireless transmission) directly to the digital camera. Thus, “cartridge” as used herein, refers to any device that stores images, whether those images be analog or digital.

The control program that controls the categorization functions described above is stored in memory 113 of the image display device 1. The control program could be stored in memory 113 in advance, e.g., by the manufacturer of device 1, or could be added thereto by the user. Thus, the invention further includes, as another aspect, a carrier wave encoded with the control program (described above) that is readable by the controller (a computer) to control the image display device 1 to function as described above. The carrier wave can be transmitted over a communications network such as, for example, the World Wide Web, and/or transmitted in a wireless fashion, for example, by radio waves or by infrared waves. Additionally, or alternatively, the carrier wave can be fixed in a computer-readable recording medium, such as, for example, a CD-ROM, a computer hard drive, RAM, or other types of memories that are readily removable or intended to remain fixed within the computer.

In the illustrated embodiment, the image display device controller (microcomputer 129) is implemented using a suitably programmed general purpose computer, e.g., a microprocessor, microcontroller or other processor device (CPU or MPU). It will be appreciated by those skilled in the art, that the controller can also be implemented as a single special purpose integrated circuit (e.g., ASIC) having a main or central processor section for overall, system-level control, and separate sections dedicated to performing various different specific computations, functions and other processes under control of the central processor section. The controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer in conjunction with one or more peripheral (e.g., integrated circuit) data and signal processing devices. In general, any device or assembly of devices on which a finite state machine capable of implementing the flow charts shown in FIGS. 7-10 can be used as the controller.

While the present invention has been described with reference to preferred embodiments thereof, it is to be understood that the invention is not limited to the disclosed embodiments or constructions. To the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

What is claimed is:

1. An image display apparatus for displaying a plurality of images, comprising:
a memory that stores images;
a display; and
a controller that:
reads out the images from an image recording medium,
stores the images in the memory,
records category information relating to the image recording medium in the memory by associating the category information with the images read out from the image recording medium,
determines one image from the images to which the specific category information is associated, as a heading image relating to a specific category, and
displays on the display a list of the heading images determined for each category based on a user operation.

2. The image display apparatus of claim 1, wherein the heading image is an image which was first assigned to its corresponding category.

3. The image display apparatus of claim 1, wherein the controller permits a user to change the heading image to any image within the corresponding category.

4. The image display apparatus of claim 1, further comprising:
an image reader that reads images from the image recording medium, wherein the controller stores the read images as data in the memory.

5. The image display apparatus of claim 4, wherein the image recording medium is a film cartridge.

6. The image display apparatus of claim 5, wherein the image reader comprises:
a film feeder that feeds film from the film cartridge past an imaging station;
a light source that illuminates the film at the imaging station; and
a photosensor that converts the illuminated image into electronic data.

7. The image display apparatus of claim 1, wherein the controller displays on the display an index image of a category specified by a selected heading image, based on an operation by the user to select a specific heading image.

8. The image display apparatus of claim 1, wherein the memory is detachable from the image display apparatus.

9. A method of storing images, comprising:
reading out the images from an image recording medium,
recording category information relating to the image recording medium in a memory by associating the category information with the images read out from the image recording medium,
determining one image from the images to which specific category information is associated as a heading image relating to a specific category, and
displaying on a display a list of the heading images determined for each category based on a user operation.

10. The method of claim 9, wherein the heading image is an image which was first assigned to the category.

11. The method of claim 9, wherein the heading image is changeable to any image in the category.

12. The method of claim 9, wherein
the image recording medium is a cartridge, and
in the reading step, a plurality of the images are read from the cartridge.

13. The method of claim 12, wherein the images are retrieved from a film cartridge.

14. The method of claim 13, wherein the images are retrieved by:
illuminating the film withdrawn from the film cartridge;
detecting an image from the illuminated film; and
converting the image into electronic data.

15. The method of claim 9, further comprising displaying an index image of a specific category based on a user selecting a specific heading image.

16. A non-transitory computer-readable storage medium storing a computer-readable control program for use by a controller of an image display device, the control program including instructions for:
reading out images from an image recording medium,
recording category information relating to the image recording medium in a memory by associating the category information with the images read out from the image recording medium,
determining one image from the images to which specific category information is associated as a heading image relating to a specific category, and
displaying on a display a list of the heading images determined for each category based on a user operation.

17. The non-transitory computer-readable storage medium of claim 16, wherein the determining instruction determines, as the heading image for each category, the first image assigned to the category.

18. The non-transitory computer-readable storage medium of claim 16, wherein the heading image for each category is changeable to any image associated with the category.

19. The non-transitory computer-readable storage medium of claim 16, including a computer-readable medium on which the carrier wave is recorded.

20. The image display apparatus of claim 1, wherein the controller reads an image from a plurality of image recording mediums, each of the heading images corresponds to a respective one of the plurality of image recording mediums.

21. The method of claim 9, wherein a plurality of the heading images are determined, each of the plurality of heading images being determined respectively for each of a plurality of image recording mediums.

22. The non-transitory computer-readable storage medium of claim 16, wherein a plurality of the heading images are determined, each of the plurality of heading images being determined respectively for a plurality of image recording mediums.
